(19) United States
(12) Patent Application Publication
(10) Pub. No.: US 2002/0163536 A1
(43) Pub. Date: Nov. 7, 2002

(54) System for and method of providing a new client interface to an existing application

(75) Inventor: Neil Hickey, Golden, CO (US)

Correspondence Address: Sam Pasternack, Choate, Hall & Stewart, 53 State Street, Exchange Place, Boston, MA, 02109, US

(73) Assignee: Orchid Systems, Inc., Wellesley, MA (US)

(21) Appl. No.: 09/846,755

(22) Filed: May 1, 2001

(51) Int. Cl. G06F 13/00

(52) U.S. Cl. 345/744

(57) ABSTRACT

A system for and method of providing a new client interface to an existing application. The various embodiments described employ a trainable user interface translator application to monitor, analyze, and reformat data packet streams. The translator application analyzes data packet streams during a training session using a first client device and a training terminal, and stores format information in format data packet maps for subsequent use following creation of a new client interface.

### FIELD OF THE INVENTION

The present invention relates generally to providing a new client interface to an existing application. More specifically, the invention employs trainable user interface translator software to monitor data streams between a client device and the existing application to create data packet maps that may be used in creating new interfaces. The invention has applications in the field of business software.

### BACKGROUND OF THE INVENTION

As client interfaces associated with existing computer systems become outdated or incompatible with newer client devices, it is often necessary to provide an alternative client interface to existing applications. For example, a merchandise supplier may want to make its inventory software available to personnel using hand-held wireless devices to increase efficiency. However, the data on existing systems is often difficult to access, either because of the proprietary nature of the system or because the data is in a nonstandard format. Current methods of creating a new client interface are limited to accessing data manually, which is time-intensive and costly, or rewriting the host application, in which case large amounts of existing business logic must be recreated. For businesses with existing systems, a faster and more effective way to update a client interface could result in more efficient business practices, higher customer satisfaction, and higher revenues.

There are rapidly developing technologies and associated devices (for example, Web, wireless, voice, etc.) in which users need to access data residing on existing computer systems. These existing systems range in variety from legacy mainframe applications to Microsoft Windows applications. Many existing systems have no standard protocols by which newer devices can access their data, and yet newer devices are often the key to the most efficient business practices. What is needed is a way to efficiently provide an additional interface to an existing system. A method which achieves this objective while enabling utilization of the error-checking functionality of the existing computer system would be beneficial.

Data often needs to be transferred between existing computer systems and these newer devices. For example, when a financial institution converts its operations to an application service provider (ASP), it must migrate large amounts of the data on its legacy system to applications used by the ASP. However, most existing systems do not support the standard protocols for transferring data to the newer devices. In the case of business applications, this may result in lower productivity and unsatisfied customers. What is needed is a way to quickly get data into and out of an existing system.

Additionally, manufacturers of existing computer applications often restrict data accessibility within their systems. Businesses that own proprietary systems often need to access such data within that system. For example, a business may want to move its operations from a proprietary system to a more open system. However, the data within the proprietary system may not easily be accessed because of license agreements. What is needed is a way to get data into and out of a closed or proprietary system.

Data streams associated with a user interface often need to be monitored because the functionality of existing systems must frequently be rapidly updated to a new appearance or for use with newer technologies. The traditional method of monitoring data streams is to analyze the data directly through a published format. However, if the data format is not published or the system is proprietary, this task can be difficult or impossible. What is needed is a way to more effectively monitor the data streams used to provide a user interface without causing some existing computer system performance degradation.

### SUMMARY OF THE INVENTION

The present invention is a system for and method of providing a new client interface to an existing application. The embodiments described below share the ability to monitor, reinterpret, and reformat data packet streams by means of a shaper computer operating a software training application. The techniques employed in the current invention build upon “trainable user interface translator” technology (referred to below as “TeleShaper” technology) as described in U.S. Pat. Nos. 5,627,977 and 5,889,516, which are assigned to the assignee of the present application and the contents of which are hereby incorporated by reference in their entirety into the present application.

In one aspect, the present invention is a trainable system for providing a new client interface to an existing application, comprising a shaper computer operating a trainable user interface translator application and further comprising and storing a shaper rule set and data packet format maps identifying data formats acceptable to a host application, and an auxiliary database for storing training data sets, a training terminal electrically connected to the shaper computer for establishing the shaper rule set and data packet format maps during a training session, a host computer electrically connected to the shaper computer and a first client device operating first client software, the host computer operating the host application, thereby generating data streams to and from the first client software that may be monitored and analyzed by the shaper computer to establish the shaper rule set and data packet format maps, a second client device electrically connected to the shaper computer upon which a new client interface is implemented, wherein the shaper computer communicates user data between the new client interface and the host application, whereby the trainable user interface translator application remaps the user data according to the data packet format maps defined during the training session and transmits the remapped user data to the second client device for presentation in the new client interface. The various electrical connections of the system may be established either directly, or alternatively by one or more networks.

In another embodiment, the host computer and the first client device are the same computer.

In another embodiment, the shaper computer and the second client device are the same computer.

In another aspect, the present invention is a method of training the system above to provide a new client interface to the host application, comprising the steps of selecting training data sets designed to fully exercise the host application, entering a training data set into the trainable user interface translator application, operating the trainable user interface translator application via the training terminal and first client device to exercise the host application to generate streams of data packets between the host application and the first client device, analyzing the format of the data packets to create packet maps and storing the packet maps, entering new training data via the training terminal into the trainable user interface translator application, which creates modified data packets according to the packet maps and transmits the modified data packets to the host computer, which in turn updates data stored in the data storage device and generates response data packets, exercising the host application via the first client device to review the presence of updated data, repeating the steps above with data expected to create exceptions and errors in the operation of the host application, and determining if all data packet formats have been mapped, and if not repeating the steps above.

In another aspect, the present invention is a method of using a trained system to provide a new client interface to the host application, comprising the steps of designing and implementing a new client interface on the second client device, starting via the training terminal the trainable user interface translator application and selecting a data packet format map, operating the second client device to communicate with the host application via the shaper computer, which remaps data packets transmitted from the host application according to the data packet format maps and forwarding remapped data packets to the second client device for presentation in the new client interface, and determining whether to continue using the new client interface, and if so, reverting to the previous step.

The present invention provides an updated interface to an existing application, while utilizing the error-checking functionality within the business logic of an existing application. It accomplishes these objectives in a manner that is noninvasive to the existing system.

### BRIEF DESCRIPTION OF THE DRAWINGS

FIG. 1 is a schematic diagram of a system for providing a new client interface to an existing application.

FIG. 2 is a flow diagram illustrating a method of training a trainable system to provide a new client interface to an existing application.

FIG. 3 is a flow diagram illustrating a method of using a trained system to provide a new client interface to an existing application.

### DETAILED DESCRIPTION

Preferred embodiments of the invention will now be described with reference to the accompanying drawings.

The present invention is a system for and method of providing a new interface to an existing application. The system non-invasively monitors and analyzes the data stream associated with an existing application, generates data packet format maps during a training sequence, and then interfaces with the application's back-end by creating compatible data packets using data entered via a new interface and extracts response data for use in the new client interface. The new interface may be a new interactive client (e.g. a web or wireless browser) or a data connector used to integrate the application into a larger integrated system (e.g. via a middleware messaging manager).

The existing applications back-end is not modified. Rather, it continues to operate with the new interface effectively “emulating” the network behavior of the application's client interface. The network packets may be associated with a proprietary data transfer format, a standard protocol (e.g. HTML/HTTP), or a low level display protocol (e.g. X-Windows).

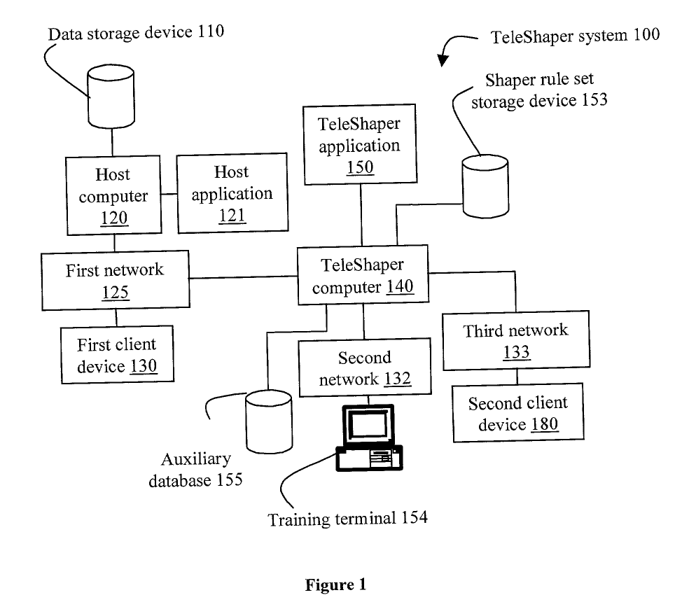

FIG. 1 is a schematic representation of a TeleShaper system 100, which includes a host computer 120, a TeleShaper computer 140, a training terminal 154, a first client device 130, and a second client device 180. Host computer 120 includes a data storage device 110 and a host application 121. TeleShaper computer 140 includes a TeleShaper application 150, a shaper rule set storage device 153, and an auxiliary database 155. TeleShaper system 100 also includes a first network 125, a second network 132, and a third network 133, arranged as shown in the figure.

Host computer 120 and first client device 130 and TeleShaper computer 140 are interconnected via first network 125. TeleShaper computer 140 is able to monitor network traffic between host computer 120 and first client device 130. Training terminal 154 may connect to TeleShaper computer 140 via second network 132. Second client device 180 may connect to TeleShaper computer 140 via third network 133. First network 125, second network 132, and third network 133 may be intranet networks or the Internet. Alternatively, first network 125, second network 132, and third network 133 may be the same network. Further, in an alternative embodiment, a direct connection may be arranged between host computer 120 and TeleShaper computer 140, between training terminal 154 and TeleShaper computer 140, and between second client device 180 and TeleShaper computer 140.

For example, host computer 120 may be an Windows-NT computer, or a similar system, and first client device 130 may be an IBM PC running application specific client software. Host application 121 may be a hospital's patient care software application. Host computer 120 and first client device 130 may be the same computer, in which case interprocess communications between the host process of host application 121 and the client process are monitored rather than network communication via first network 125. For example, if host computer 120 is running Windows 95 and host computer 120 and first client device 130 are the same computer, the communication between host application 121 and the operating system is monitored.

Training terminal 154 is typically a PC client running telnet, but may also be a hardwired terminal or a display and keyboard directly connected to TeleShaper computer 140.

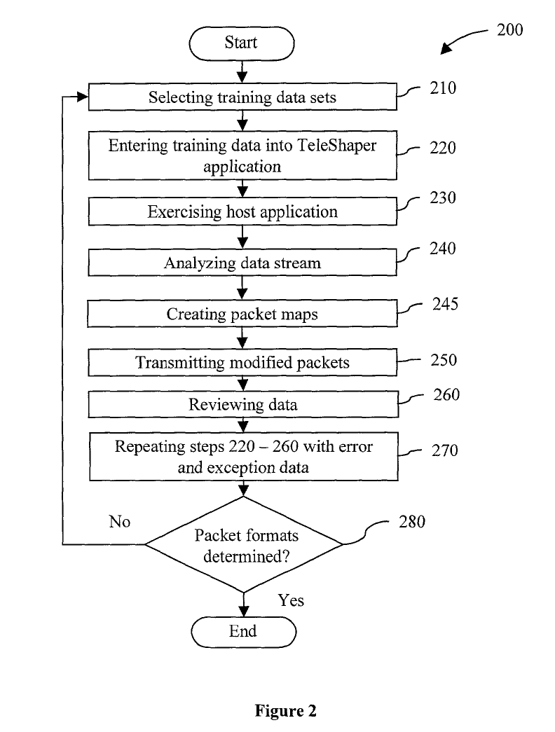

A method of training TeleShaper system 100 to provide a new client interface to an existing application is now described with reference to FIG. 2.

Step 210: Selecting Training Data Sets

In this step, the trainer selects training data sets that are designed to fully exercise host application 121. The selection of the data sets is based on the trainer's understanding of the operation of host application 121. The trainer records the data sets on paper, or on paper and in a data file stored on TeleShaper computer 140. If host application 121 were patient care application, an example of training data might be a list of medicine administration sets composed of patient names, drug names, and administration times.

Step 220. Entering Training Data into TeleShaper Application

In this step, the trainer enters the training data developed in step 210 into auxiliary database 155 for eventual processing in TeleShaper application 150.

Step 230: Exercising Host Application

In this step, the trainer, using training terminal 154, places TeleShaper application 150 into training mode. The trainer then exercises host application 121 via first client device 130, using the training data developed in step 210. This results in streams of data “packets,” or data streams, passing between first client device 130 and host application 121. These packets are recorded by TeleShaper computer 140, which is monitoring traffic on network 124.

Step 240: Analyzing Data Stream

In this step, the trainer, via training terminal 154, instructs TeleShaper application 150 to analyze the data streams generated recorded in step 230. TeleShaper application 150 locates the variable data within the data packets in order to determine the layout of each data packet.

Step 245: Creating Packet Maps

In this step, TeleShaper application 150 creates packet maps. These packet maps describe the data packet formats, such as fixed width, comma delimited, etc., and are stored in rule set storage device 153. The offset within each packet at which to extract or insert variable data is recorded as well as additional formatting information necessary to create new properly formatted packets. This information might include, for example, checksum locations and methods, and offset tables that are part of the packet.

Step 250: Transmitting Modified Packets

In this step, the trainer, using training terminal 154, enters new training data into TeleShaper application 150. TeleShaper application 150 then creates new data packets according to the packet maps defined in step 245 and transmits the data packets to host computer 120, which will act on the data in the generated packets by updating data stored in data storage device 110 and also by generating response data. TeleShaper application 150 monitors and records the response data packets from host computer 120 and compares them to the expected format for response packets detected in step 240.

Step 260: Reviewing Data

In this step, the trainer, using first client device 130, exercises host application 121 to review the presence of the test data stored by host application 121 in data storage device 110. The trainer is then able to confirm that the training data used in step 250 was correctly interpreted and stored by host application 121.

Step 270: Repeating Steps 220-260 with Error and Exception Data

In this step, steps 220-260 are repeated with data that is expected to create exceptions and errors in the operation of host application 121, so that the format of the response data packets associated with error and exceptions generated by host application 121 can be completely mapped.

Step 280. Packet Formats Determined?

In this step, the trainer determines if the training data packet formats have been completely determined and stored in shaper rule set storage device 153. If no, process 200 returns to step 210; if yes, process 200 ends.

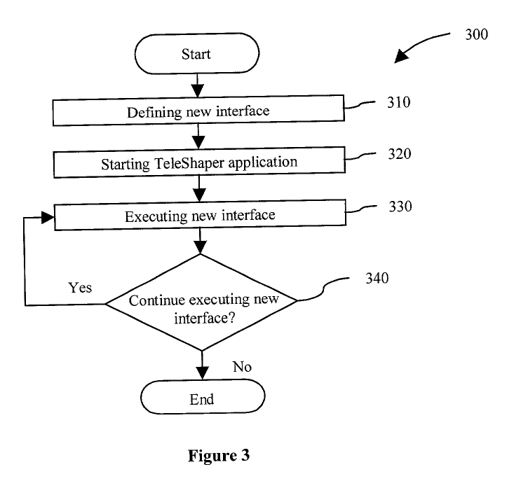

A method of using TeleShaper system 100 to provide a new client interface to an existing application is now described with reference to FIG. 3.

Step 310: Defining New Interface

In this step, the trainer designs a new interface for host application 121 using traditional tools (for example, Web development tools, wireless-enablement tools, database programming tools, etc.). The trainer then implements the new interface on TeleShaper computer 140 or second client device 180. The new interface communicates with TeleShaper application 150 using standard protocols, such as ODBC, JDBC, etc., depending on the application.

Step 320: Starting TeleShaper Application

In this step, the user, using training terminal 154, starts TeleShaper application 150. The user selects the appropriate packet map and host connectivity.

Step 330: Executing New Interface

In this step, the user operates second client device 180, which communicates with host application 121 via TeleShaper computer 140. User data is transferred between host application 121, remapped according to the packet maps defined in process 200, and transmitted to second client device 180, where it is presented to the user in the new interface. TeleShaper application 150 monitors all response packets and records any unexpected response packets as well as the associated data packet for later analysis. This allows process 200 to be repeated, if necessary to further refine the operation of the system.

Step 340: Continue Executing New Interface?

In this step, the user determines whether to continue using the new interface on second client device 180. If yes, process 300 returns to step 330; if no, process 300 ends. The new interface and associated data reformatting between host application 121 and second client device 180 continues as long as the user operates host application 121 or until TeleShaper application 150 is disabled.

Another use for process 300 is to provide a rapid means of creating an alternate interface to a Web site when communication between host application 121 and second client device 180 is a known protocol, such as HTML, XML, etc.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A trainable system for providing a new client interface to an existing application, comprising:
a shaper computer operating a trainable user interface translator application and further comprising and storing a shaper rule set and data packet format maps identifying data formats acceptable to a host application, and an auxiliary database for storing training data sets;
a training terminal electrically connected to the shaper computer for establishing the shaper rule set and data packet format maps during a training session;
a host computer electrically connected to the shaper computer and a first client device operating first client software, the host computer operating the host application, thereby generating data streams to and from the first client software that may be monitored and analyzed by the shaper computer to establish the shaper rule set and data packet format maps;
a second client device electrically connected to the shaper computer upon which a new client interface is implemented;
wherein the shaper computer communicates user data between the new client interface and the host application, whereby the trainable user interface translator application remaps the user data according to the data packet format maps defined during the training session and transmits the remapped user data to the second client device for presentation in the new client interface.

2. The trainable system of claim 1, wherein one or more of the electrical connections are implemented on one or more networks.

3. The trainable system of claim 1, wherein one or more of the electrical connections are direct connections.

4. The trainable system of claim 1, wherein the host computer and the first client device are the same computer.

5. The trainable system of claim 1, wherein the shaper computer and the second client device are the same computer.

6. In a trainable system comprising a shaper computer operating a trainable user interface translator application and storing data packet format maps, a training terminal electrically connected to the shaper computer, a host computer electrically connected to the shaper computer and a first client device, further comprising a data storage device and operating a host application, thereby generating streams of data packets to and from the first client device, and a second client device electrically connected to the shaper computer, a method of training the trainable system to provide a new client interface to the host application, comprising the steps of:
selecting training data sets designed to fully exercise the host application;
entering a training data set into the trainable user interface translator application;
operating the trainable user interface translator application via the training terminal and first client device to exercise the host application to generate streams of data packets between the host application and the first client device;
analyzing the format of the data packets to create packet maps and storing the packet maps;
entering new training data via the training terminal into the trainable user interface translator application, which creates modified data packets according to the packet maps and transmits the modified data packets to the host computer, which in turn updates data stored in the data storage device and generates response data packets;
exercising the host application via the first client device to review the presence of updated data;
repeating the steps above with data expected to create exceptions and errors in the operation of the host application; and
determining if all data packet formats have been mapped, and if not repeating the steps above.

7. In a trained system comprising a shaper computer operating a trainable user interface translator application and storing data packet format maps, a training terminal electrically connected to the shaper computer, a host computer electrically connected to the shaper computer and a first client device, and operating a host application, thereby generating streams of data packets to and from the first client device, and a second client device electrically connected to the shaper computer, a method of using the trained system for providing a new client interface to the host application, comprising the steps of:
designing and implementing a new client interface on the second client device;
starting via the training terminal the trainable user interface translator application;
operating the second client device to communicate with the host application via the shaper computer, which remaps data packets transmitted from the host application according to the data packet format maps and forwarding remapped data packets to the second client device for presentation in the new client interface; and
determining whether to continue using the new client interface, and if so, reverting to the previous step.
